(19) United States
(12) Patent Application Publication
(10) Pub. No.: US 2026/0340133 A1
(43) Pub. Date: Oct. 29, 2026

(54) Post-Deployment Code Validation

(71) Applicant: Oracle International Corporation, Redwood Shores, CA (US)

(72) Inventors: Benjamin Roux, Seattle, WA (US); Kourosh Lashgari, Sammamish, WA (US)

(73) Assignee: Oracle International Corporation, Redwood Shores, CA (US)

(21) Appl. No.: 19/364,599

(22) Filed: Oct. 21, 2025

Related U.S. Application Data
(60) Provisional application No. 63/796,732, filed on Apr. 29, 2025.

(51) Int. Cl. G06F 21/57; H04L 9/32

(52) U.S. Cl. CPC G06F 21/572; H04L 9/3247; G06F 2221/033

(57) ABSTRACT

Techniques for post-deployment code validation are disclosed. A first entity system obtains, from a second entity system, a signed code package that includes a digital signature applied by the second entity system to a set of code to be deployed to a target computing environment. The first entity system exposes an interface for the second entity system to validate the digital signature and communicate a validation signal to the first entity system. The digital signature indicates that the set of code satisfies one or more deployment criteria enforced by the second entity system. Validation of the digital signature, by the second entity system, determines if the set of code in the signed code package has been altered since the second entity system applied the digital signature to the set of code.

### BENEFIT CLAIMS; RELATED APPLICATIONS; INCORPORATION BY REFERENCE

This application claims the benefit of U.S. Provisional Patent Application 63/796,732, filed Apr. 29, 2025, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to code deployment. In particular, the present disclosure relates to establishing trust in code deployment.

### BACKGROUND

An integrated lights out manager (ILOM) is an embedded server management technology that allows out-of-band management capabilities, allowing administrators to remotely manage, monitor, and troubleshoot servers, even if the main network or operating system is down.

In a hosted environment, a customer rents or leases a server from a hosting provider. From time to time, the provider may deploy code to the server's ILOM (e.g., for repair orchestration). A malicious actor associated with the provider (e.g., a rogue employee) may deploy unsanctioned code that attempts to exploit the ILOM (e.g., via a firmware update) to gain unauthorized access to the customer's environment on the server. In addition, a malicious actor associated with the customer may tamper with code being deployed to the ILOM to gain unauthorized access to other resources in the hosted environment (e.g., another customer's server and/or hosting infrastructure).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates a system in accordance with one or more embodiments;

FIGS. 2A-2C illustrate an example set of operations for mutually trusted code deployment in accordance with one or more embodiments;

FIGS. 3A-3B illustrate an example set of operations for post-deployment code validation in accordance with one or more embodiments;

FIGS. 4A-4G illustrate an example of mutually trusted code deployment and post-deployment code validation in accordance with one or more embodiments;

FIGS. 5-8 are block diagrams illustrating patterns for implementing a cloud infrastructure as a service system in accordance with one or more embodiments; and

FIG. 9 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is generally used to refer to a service that is made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are various different types or models of cloud services including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity, and the like. When a customer subscribes to or registers for a service provided by a CSP, a tenancy, or an account, is created for that customer. The customer can then, via this account, access the subscribed-to one or more cloud resources associated with the account.

### TABLE OF CONTENTS

1. GENERAL OVERVIEW
2. MUTUALLY TRUSTED CODE DEPLOYMENT ARCHITECTURE
3. OPERATIONS FOR MUTUALLY TRUSTED CODE DEPLOYMENT
4. OPERATIONS FOR POST-DEPLOYMENT CODE VALIDATION
5. EXAMPLE EMBODIMENT
6. PRACTICAL APPLICATIONS, ADVANTAGES, AND IMPROVEMENTS
7. CLOUD COMPUTING TECHNOLOGY
8. COMPUTER SYSTEM
9. MISCELLANEOUS; EXTENSIONS

### 1. General Overview

One or more embodiments provide mutual trust between entities involved in a code deployment. Specifically, one or more embodiments provide mutual trust that neither party is attempting to deploy unsanctioned code or otherwise tamper with the code being deployed. For the sake of clarity and explanation, in examples described herein, the entities are a hosting provider and a customer of the hosting provider, and the target environment for the code deployment is an ILOM. Specifically, one or more embodiments provide mutual trust between a provider and a customer that for a given code deployment to an ILOM that is associated with the customer, (1) the provider is not attempting to deploy unsanctioned code, and (2) the customer has not tampered with the code being deployed. However, embodiments may be practiced with other kinds of entities seeking mutual trust in code deployments and/or within other kinds of target environments.

Operations described herein as being performed by an entity should be understood as being performed by one or more system components associated with that entity. For example, operations performed “by the provider” are performed by one or more components in the provider system. Similarly, operations performed “by the customer” are performed by one or more components in the customer system. For the sake of clarity and explanation, these components are referred to more succinctly as “the provider” and “the customer.”

In an embodiment, the provider prepares the code for deployment. The provider stores the code in a compressed file such as a zip file. If the code includes multiple files (e.g., Python scripts, class files, etc.), the compressed file includes the multiple code files. The provider uses a private key to digitally sign the code. The provider stores the digitally signed code in a repository that is mutually accessible by the provider and the customer.

In an embodiment, before approving the deployment, the customer inspects the provider-signed code to ensure the code does not include any unsanctioned instructions. The customer uses the provider's public key to access the code for inspection. The customer approves the code by digitally signing the code, resulting in mutually signed (or “double-signed”) code. The customer's digital signature also allows the customer to subsequently validate its own digital signature, as discussed in further detail below. Alternatively, or additionally, the customer provides some other form of approval.

In an embodiment, the provider accesses the mutually signed code and validates its own digital signature. Validating the provider's digital signature determines if the mutually signed code matches what the provider signed. Successful validation assures the provider that the code has not been tampered with (e.g., by the customer and/or by an intermediary) in the time since the provider signed the code. Alternatively, or additionally, the provider validates the customer's digital signature on the mutually signed code. Successfully validating the customer's digital signature assures the provider that the customer has approved the code for deployment.

In an embodiment, the provider generates a deployment package that includes the mutually signed code. The provider uses a private key to digitally sign the deployment package. The private key used for the provider's second signature is different than the private key used for the provider's first digital signature. If the provider and the customer have both signed the code already, the provider's second digital signature makes the code triple signed.

In an embodiment, the provider transmits the deployment package to a server in a deployment environment. In one example, the provider transmits the deployment package to an ILOM. Transmitting the deployment package to the server creates a copy of the deployment package on server but does not complete the deployment process. As described herein, one or more embodiments validate the provider's digital signature and/or the customer's digital signature before installing the code on the server.

In an embodiment, if the provider signed the code a second time, the provider validates its second digital signature at the server. Validating the provider's second digital signature at the server determines if the copy of the deployment package on the server matches what the provider signed. Successful validation assures the provider that the deployment package has not been altered in the time since the provider applied its second digital signature to the deployment package.

In an embodiment, before the provider installs the code on the server, the customer validates its own digital signature on the server's copy of the code. Validating the customer's digital signature determines if the code in the deployment package matches what the customer signed. Successful validation assures the customer that the code has not been altered in the time since the customer digitally signed the code. If the customer's digital signature is valid, the customer approves the code to be installed on the server. In an embodiment, installing the code on the server is conditioned on the customer's post-transmission approval. Thus, before the deployment is completed, both the provider and the customer have an opportunity to confirm that the deployment does not introduce unsanctioned code.

In an embodiment, the provider installs the code on the server. To install the code, the provider extracts the code from the deployment package. If the extracted code is not already at the appropriate location(s) on the server (e.g., one or more specific file paths), the provider copies or moves the code to the appropriate location(s). If installing the code requires compiling the code to an executable format, the provider compiles the code at the server. If installing the code requires executing a script and/or other executable file, the provider executes the appropriate file(s). In general, installing the code brings the code from its state in the deployment package to an operational state on the server.

In an embodiment, after the code is deployed, the customer performs one or more post-deployment validations to confirm that the deployed code has not been altered. The provider system leaves a copy of the unextracted, digitally signed code on the server (e.g., a copy of the deployment package). The customer system extracts the code and compares the newly extracted code with the code installed on the server. Comparing the newly extracted code with the installed code assures the customer system that the installed code matches what the customer system approved, i.e., the deployed code has not been altered from what the customer approved.

One or more embodiments deploy code written in a declarative language such as Python. Code written in a declarative language can be compared as plain text. Thus, deploying code in a declarative language facilitates the customer comparing newly extracted code with the code installed on the server. Alternatively, or additionally, the code includes compiled code. If the deployment environment is a heterogeneous environment (e.g., using standardized containers), different instances of compiling the code will result in the same executable file. Accordingly, the customer can compile the newly extracted code and compare the newly compiled code with the executable file(s) installed on the server.

In one or more embodiments, if the customer determines that the installed code does not match what the customer digitally signed, the customer and/or system take action to remediate the mismatch. In one example, the customer accesses an application programming interface (API) to disable the server in part (e.g., by disabling the ILOM without disabling the entire server) or in whole. In another example, the customer system reports a security incident. In yet another example, the customer and/or provider disable(s) and/or remove(s) the installed code.

One or more embodiments make code deployment conditioned on validating the provider's first and second digital signatures without validating the customer's digital signature. In an embodiment, the customer does not digitally sign the code. Instead, the customer provides some other kind of feedback that indicates approval of the deployment. In such cases, deployment is conditioned on (1) validating the provider's signature(s) and (2) receiving the customer's approval.

One or more embodiments described in this Specification and/or recited in the claims may not be included in this General Overview section.

### 2. Mutually Trusted Code Deployment Architecture

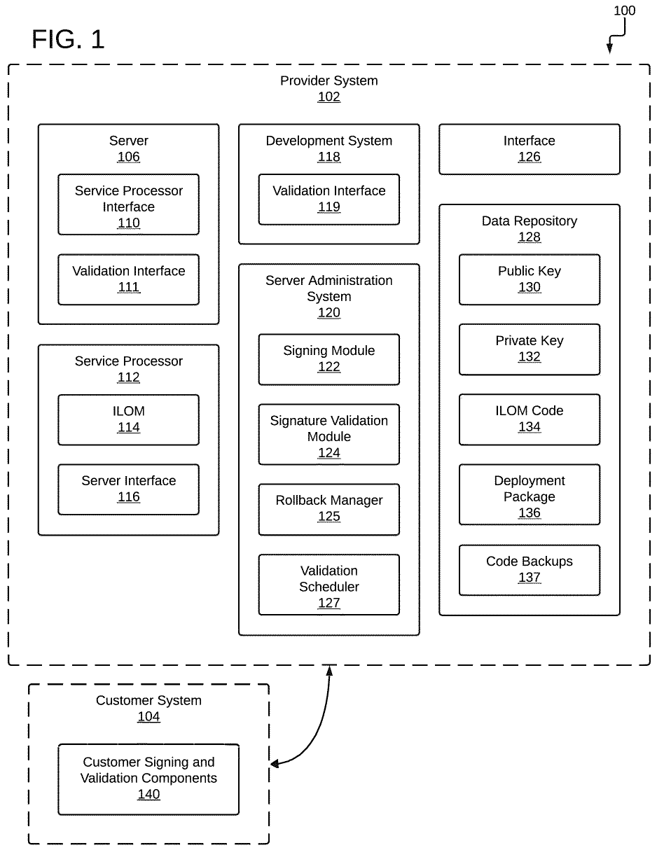

FIG. 1 illustrates a system 100 in accordance with one or more embodiments. As illustrated in FIG. 1, system 100 includes components in a provider system 102 and components in a customer system 104. In an embodiment, provider system 102 includes server 106, service processor 112, development system 118, server administration system 120, interface 126, and data repository 128. Server 106 includes service processor interface 110 and validation interface 111. Service processor 112 includes ILOM 114 and server interface 116. Development system 118 includes validation interface 119. Server administration system 120 includes signing module 122, signature validation module 124, rollback manager 125, and validation scheduler 127. Data repository 128 includes public key 130, private key 132, ILOM code 134, deployment package 136, and code backups 137. In an embodiment, customer system 104 includes customer signing and validation components 140.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. A component may be distributed over multiple applications and/or machines. Multiple components may be combined into one application and/or machine. Operations described with respect to one component may instead be performed by another component.

In an embodiment, provider system 102 is a computing environment under control of a hosting provider. Provider system 102 includes hardware and software infrastructure that the provider uses to provide hosted services to one or more customers. For example, provider system 102 may include one or more data farms. The hosted services may include one or more forms of Software as a Service (SaaS), Platform as a Service (PaaS), and/or Infrastructure as a Service (IaaS).

In an embodiment, server 106 is a computer server configured to perform one or more server functions. Some examples of server functions include data storage and management, resource provisioning, request handling, network management, security, etc. In an embodiment, server 106 is one of multiple servers in a data farm. Alternatively, or additionally, server 106 is communicatively coupled with one or more other servers in a cluster configuration. Many kinds of servers 606 and server configurations exist.

In an embodiment, service processor interface 110 provides one end of a physical connection between server 106 and service processor 112. In one example, service processor interface 110 includes a Registered Jack 45 (RJ45) port that allows for a connection between server 106 and service processor 112 via an Ethernet cable. Alternatively, or additionally, service processor interface 110 includes a Universal Serial Bus (USB) port, a wireless network interface card (NIC), a peripheral component interconnect (PCI) or PCI express (PCIe) bus, and/or any other kind of hardware interface that allows for a wired or unwired physical connection between server 106 and service processor 112.

In an embodiment, validation interface 111 is an interface that a customer can access to validate code (e.g., deployment package 136) in the deployment environment, specifically on server 106. Validation interface 111 is an application programming interface (API) that exposes one or more endpoints the customer can call to perform validation operations. In one example, an endpoint is a representational state transfer (REST) interface. Alternatively, or additionally, validation interface 111 exposes an endpoint that allows the customer to provide one or more validation signals and/or instruction(s) to perform one or more remedial actions if the validation operation(s) determine(s) the code on server 106 is not valid.

In an embodiment, service processor 112 is a device that supports management of one or more functions of server 106. In one example, service processor 112 supports management of chassis environmental, configuration, and/or service functions of server 106. Alternatively, or additionally, service processor 112 is configured to receive event data from other parts of system 600. In an embodiment, service processor 112 is part of server 106. In one example, service processor 112 is built into the same physical chassis as server 106. Alternatively, server 106 and service processor 112 are separate units in a server environment. In one example, server 106 and service processor 112 are separate units in one or more server racks. In an embodiment, server 106 and service processor 112 are communicatively coupled using respective interfaces as described herein.

In an embodiment, ILOM 114 refers to hardware, software, and/or firmware in service processor 112 that provides out-of-band management capabilities. ILOM 114 allows administrators to remotely manage, monitor, and troubleshoot server 106, even if the main network or operating system is down. In an embodiment, ILOM 114 includes firmware (not shown) that can be upgraded by deploying new firmware to ILOM 114. One or more embodiments deploy new software and/or firmware to ILOM 114 using mutually trusted code deployment.

In an embodiment, server interface 116 provides one end of a physical connection between service processor 112 and server 106. For example, server interface 110 may include an RJ45 port that allows for a connection between service processor 112 and server 106 via an Ethernet cable. Alternatively, or additionally, server interface 116 may include a USB port, a wireless NIC, and/or any other hardware interface that allows for a wired or unwired physical connection between service processor 112 and server 106.

In an embodiment, development system 118 refers to hardware and/or software configured to produce code for deployment to server 106 and/or ILOM 114. In one example, development system 118 includes one or more software tools for developing ILOM code 134 (described in further detail below) to deploy to ILOM 114. In an embodiment, development system 118 supports the development of code in a declarative language, such as Python. Alternatively, or additionally, development system 118 includes one or more tools for developing other kinds of code and/or code in different kinds of languages. As illustrated in FIG. 1, development system 118 is configured to store code (e.g., ILOM code 134) in data repository 128.

In an embodiment, validation interface 119 is an interface that a customer can access to validate code in a development environment, specifically in development system 118. Validation interface 119 is an application programming interface (API) that exposes one or more endpoints the customer can call to perform validation operations. In one example, an endpoint is a representational state transfer (REST) interface. Alternatively, or additionally, validation interface 119 exposes an endpoint that allows the customer to provide one or more validation signals and/or instruction(s) to perform one or more remedial actions if the validation operation(s) determine(s) the code in deployment system 118 is not valid.

In an embodiment, server administration system 120 refers to hardware and/or software configured to administer one or more functions of server 106 and/or service processor 112. Server administration system 120 includes a signing module 112 configured to digitally sign data and a signature validation module 124 configured to validate digital signatures. Server administration system 120 may be configured to package digitally signed code for deployment. Server administration system 120 may be configured to transmit a deployment package to server 106 and/or ILOM 114. Server administration system 120 may be configured to perform other provider-side operations described herein for mutually trusted code deployment.

In an embodiment, signing module 112 is configured to use one or more private keys 132 to digitally sign data. In one example, signing module 112 is configured to hash the data using a hash algorithm such as SHA-256. Signing module 112 is configured to encrypt the hash using a private key 132, to obtain a digital signature. Signing module 112 is configured to attach the digital signature to the data, thus digitally signing the data. Alternatively, or additionally, signing module 122 is configured to use another digital signing technique.

In an embodiment, signature validation module 124 is configured to use one or more public keys 630 to validate digital signatures. In one example, signature validation module 124 is configured to receive digitally signed data. Signature validation module 124 is configured to hash the data using the same hash algorithm used to sign the data (e.g., SHA-256). Signature validation module 124 is configured to use the sender's public key 624 to decrypt the digital signature, to obtain the hash ostensibly generated by the sender. If the hash generated by the signature validation module 124 matches the hash in the digital signature, then the digital signature is valid. A valid digital signature means that the data is authentic (i.e., came from the holder of the private key corresponding to the public key 624), untampered (i.e., has not been altered since it was digitally signed), and non-repudiable (i.e., the sender cannot deny signing the data).

In an embodiment, rollback manager 125 is configured to roll back code on server 106. Specifically, rollback manager 125 is configured to roll back the code from a version installed on server 106 to a previous version stored in data repository 128 as code backup 137. In an embodiment, in addition to rolling back the code itself, rollback manager 125 is configured to handle configuration changes, database migrations, and/or environment settings needed to revert the code to a last valid version.

In an embodiment, validation scheduler 127 is configured to manage validation schedules for post-deployment code validation. Specifically, validation scheduler 127 is configured to initiate code validation if/when a scheduling criterion is satisfied. The schedule may indicate that code validation should occur periodically, at predefined intervals, and/or responsive to detecting a triggering event (e.g., a reboot, an instruction received from customer system 104, etc.).

In one or more embodiments, interface 126 refers to hardware and/or software configured to facilitate communications between a user and one or more components in provider system 102. Interface 126 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 126 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 126 is specified in one or more other languages, such as Java, C, or C++.

In one or more embodiments, a data repository 128 is any type of storage unit and/or device (e.g., a file system, database, collection of tables, or any other storage mechanism) for storing data. Further, a data repository 128 may include multiple different storage units and/or devices. The multiple different storage units and/or devices may or may not be of the same type or located at the same physical site. Further, a data repository 128 may be implemented or executed on the same computing system as one or more other components of system 100. Alternatively, or additionally, a data repository 128 may be implemented or executed on a computing system separate from one or more other components of system 100. The data repository 128 may be communicatively coupled to one or more other components of system 100 via a direct connection or via a network. Furthermore, data sets illustrated within the data repository 128 may include may be implemented across any of components within the system 100, in a decentralized and/or distributed manner. The data sets are illustrated within the data repository 128 for purposes of clarity and explanation.

In one or more embodiments, the data repository 128 stores public key 130, private key 132, ILOM code 134, deployment package 136, and/or code backup 13. A public key 130 is a cryptographic key that is shared openly and used for asymmetric encryption. A public key 130 has a corresponding private key 132 that is kept secret by the sender and used by the sender to apply digital signatures. Together, the public key 130 and private key 132 form a public/private key pair. One or more embodiments include a public key 130 associated with the provider's private key 132. The provider supplies the public key 130 to one or more other entities, e.g., customers. One or more embodiments also include a public key 130 given to the provider by the customer. In an embodiment, the provider uses the customer's public key 130 to validate the customer's digital signatures.

In an embodiment, ILOM code 134 is code to be deployed to ILOM 114. ILOM code 634 includes software and/or firmware. In one example, ILOM code 134 includes a firmware upgrade for the ILOM 114. In an embodiment, ILOM code 134 includes code written in a declarative programming language, such as Python. Alternatively, or additionally, ILOM code 134 includes code written in another programming language. One or more embodiments may be practiced with code to be deployed to a target environment other than an ILOM 114.

In an embodiment, a deployment package 136 is a package that includes ILOM code 134 and/or other code to be deployed. The deployment package 136 also includes one or more digital signatures. In an embodiment, if the ILOM code 134 includes multiple artifacts (e.g., multiple Python scripts), the deployment package 136 includes a version of the ILOM code 134 wrapped into a single file, such as a zip file. The deployment package 136 includes one or more digital signatures applied to the ILOM code 134 (e.g., to the zip file). The digital signature(s) include one or more of a digital signature applied by signing module 122 using a private key 132 and/or a digital signature applied by the customer using a different signing module (not shown) in customer system 104. The deployment package 136 itself may be signed by the provider using a private key 132, which may be the same private key as the one used to sign the ILOM code 134 or a different private key.

In an embodiment, code backups 137 include one or more sets of code corresponding to prior versions deployed to server 106. Code backups 137 include at least one set of code that customer system 104 has previously validated. Code backups 137 further include metadata, such as deployment dates, the identity of an account that validated the code, and/or other information associated with prior code deployments and/or validations. In an embodiment, rollback manager 125 is configured to access code backups 137 to perform rollbacks if code deployed to server 106 is not valid.

In an embodiment, customer signing and validation components 140 refers to one or more components in customer system 104 that are under the customer's control. For example, customer signing and validation components 140 may include one or more components configured to apply the customer's digital signature using the customer's private key, validate the customer's digital signature using the customer's public key, and/or validate the provider's digital signature using the provider's public key.

In an embodiment, components of system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Operations For Mutually Trusted Code Deployment

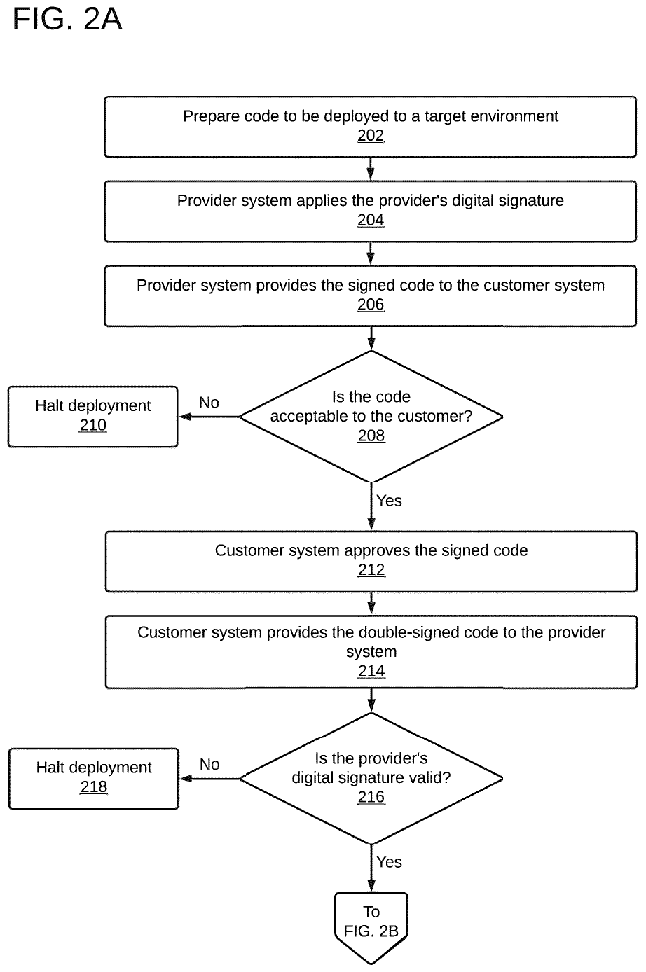

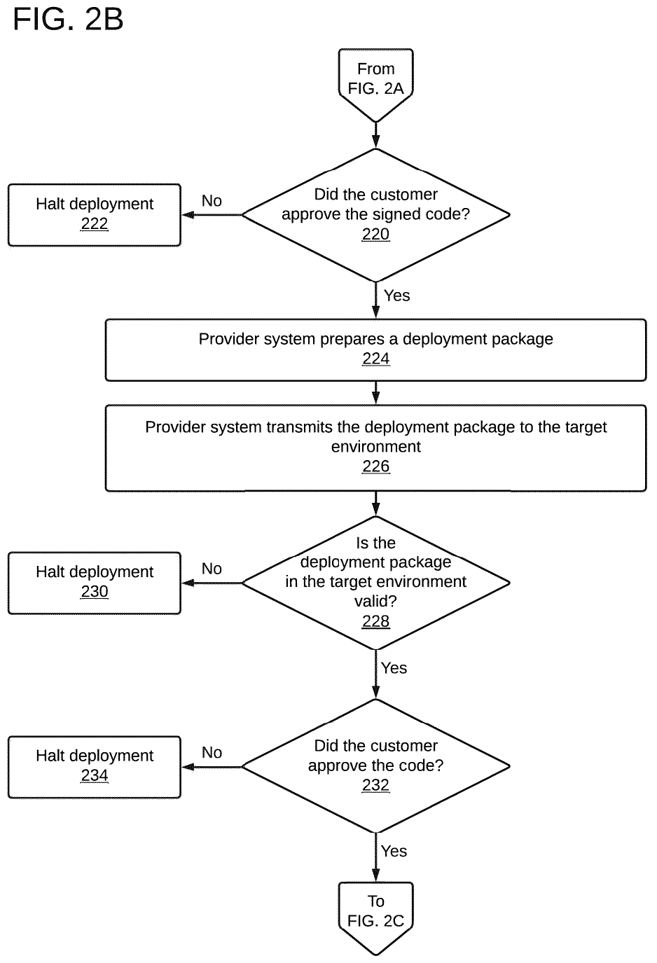

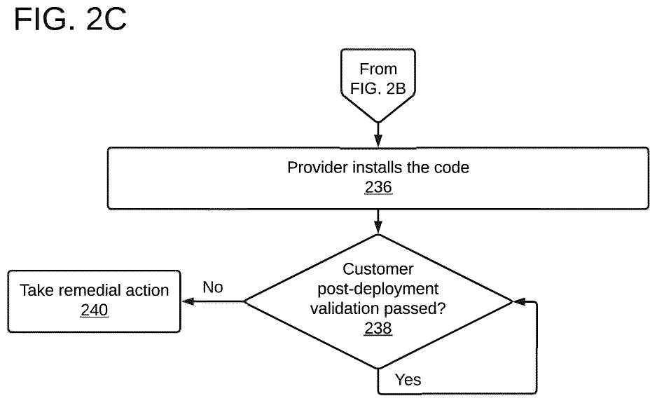

FIGS. 2A-2C illustrate an example set of operations for mutually trusted code deployment in accordance with one or more embodiments. One or more operations illustrated in FIGS. 2A-2C may be modified, rearranged, or omitted. Accordingly, the particular sequence of operations illustrated in FIGS. 2A-2C should not be construed as limiting the scope of one or more embodiments.

In an embodiment, a provider system prepares code to be deployed to a target environment (Operation 202). Specifically, responsive to user input in an integrated development environment (IDE) or other programming tool, a development system under control of the provider generates the code. In an embodiment, the code includes multiple scripts in a declarative programming language such as Python. The provider system may compress the scripts into a zip file that can be treated as a single unit of data. Compressing the scripts into a zip file makes the code easier to transmit between different components of the provider system, including to the target environment. In addition, compressing the scripts into the zip file allows the provider system and/or customer system to digitally sign the code as a single unit rather than needing to digitally sign multiple scripts independently.

In an embodiment, the provider system applies the provider's digital signature to the code (Operation 204). Specifically, the provider system uses a private key associated with the provider to apply the provider's digital signature to the code. If the code is compressed in a zip file, the provider system applies the provider's digital signature to the zip file. In this example, the provider system digitally signs the code before the customer system digitally signs the code (discussed in further detail below). In another embodiment, the customer system digitally signs the code before the provider system digitally signs the code. In another embodiment, the customer's digital signature is optional.

In an embodiment, the provider system provides the signed code to the customer system (Operation 206). In one example, the provider system stores the signed code, i.e., the code to which the provider's signature has been applied, in a data repository that is accessible to both the provider system and the customer system. Storing the signed code in the data repository allows the customer system to access the code via the data repository.

In an embodiment, the customer system determines if the code is acceptable (Operation 208). The customer system determines if the code is acceptable in one or more of various possible ways. In one example, the customer system uses the provider's public key to validate the provider's digital signature. Validating the provider's digital signature confirms that the signed code accessible to the customer system is the same code that the provider system digitally signed.

Alternatively, or additionally, the customer system extracts the code (e.g., by decompressing the zip file) for inspection. In an embodiment, the customer system performs one or more automated tests, i.e., tests performed by the system without user intervention, to inspect the code. In one example, the customer system parses lines of code to determine if the code includes any unsanctioned instructions. Unsanctioned instructions are instructions that the customer does not permit in the target environment because they could be used to hijack computing resources and/or compromise security in the customer's hosted server (e.g., by accessing sensitive data). In one example, the inspection identifies an instruction to obtain data from data storage in the customer's hosted server, indicating that a malicious actor (e.g., a rogue developer with access to the code before the digital signing process) has introduced potentially malicious instructions to the code.

In an embodiment, if the automated test fails, the customer system presents the code in a GUI for further human inspection. The customer system marks the code (e.g., using annotations) to indicate the location(s) of unsanctioned instructions in the code. In an embodiment, the code is unacceptable to the customer if human review confirms that the unsanctioned code is unacceptable. Alternatively, the customer system determines that the code is unacceptable based on one or more automated tests without human review.

In an embodiment, if the code is not acceptable to the customer, the provider system halts the deployment (Operation 210). To indicate that the code is not acceptable, the customer system refrains from transmitting an approval message to the provider system within a predetermined amount of time (e.g., within forty-eight hours) of the signed code being made available to the customer system. Alternatively, or additionally, the customer system transmits a message to the provider system indicating that the customer does not approve the signed code.

In an embodiment, halting the deployment causes the provider system to refrain from performing further operations that would advance the deployment. Alternatively, or additionally, the provider system generates a message in a log file and/or user interface indicating that the deployment is halted. The message includes a reason, i.e., one or more tags, natural language sentences, etc. indicating that the code is not acceptable to the customer. In an embodiment, responsive to the message, the provider initiates a root cause investigation into the operations that resulted in the code not being acceptable to the customer.

In an embodiment, if the code is acceptable to the customer, the customer system approves the signed code (Operation 212). The customer system approves the signed code in one or more of various possible ways. In an embodiment, the customer system transmits a message (optionally responsive to user input) to the provider system indicating that the customer approves the signed code. Alternatively, or additionally, the customer system applies the customer's digital signature to the signed code. Specifically, the customer system uses a private key associated with the customer to apply the customer's digital signature to the code. If the code is compressed in a zip file, the customer system applies the customer's digital signature to the zip file. In this example, the customer system digitally signs the code after the provider system digitally signs the code (discussed in further detail above). In another embodiment, the provider system digitally signs the code after the customer system digitally signs the code. In yet another embodiment, the customer's digital signature is optional.

In an embodiment, the customer system provides the double-signed code to the provider system (Operation 214). Specifically, the customer system stores the double-signed code, i.e., the code to which both the provider's signature and the customer's signature have been applied, in a data repository that is accessible to both the provider system and the customer system. Storing the double-signed code in the data repository allows the provider system to access the code via the data repository. As noted above, in an embodiment, the customer's digital signature is optional. If the customer's digital signature is optional and the customer system did not digitally sign the signed code, the customer system provides the signed code with the provider's digital signature, in which case operations described herein that refer to double-signed code apply to the signed code instead.

In an embodiment, the provider system determines if the provider's digital signature accompanying the code is valid (Operation 216). The provider system determines if the provider's digital signature is valid by attempting to validate the provider's digital signature using the provider's public key. An invalid signature indicates that the code is not the same code that the provider system signed. The provider's digital signature is invalid, for example, if a malicious actor tampered with the code at some point after the provider system signed the code. Tampering with the code would change the output of the hash function so that it does not match the hash code in the digital signature. In this example, if the attempt to validate the digital signature fails, the provider's digital signature is not valid.

In an embodiment, if the provider's digital signature is not valid, the provider system halts the deployment (Operation 218). Halting the deployment causes the provider system to refrain from performing further operations that would advance the deployment. Alternatively, or additionally, the provider system generates a message in a log file and/or user interface indicating that the deployment is halted. The message include a reason, i.e., one or more tags, natural language sentences, etc. indicating that the provider's digital signature is not valid. In an embodiment, responsive to the message, the provider initiates a root cause investigation into the operations that resulted in the digital signature being invalid.

In an embodiment, the system determines if the customer approved the signed code (Operation 220). To determine if the customer approved the signed code, the provider system determines if the customer system has transmitted a message indicating that the customer approves the signed code. Alternatively, or additionally, if the code is double-signed, the provider system attempts to validate the customer's digital signature. An invalid signature indicates that the code is not the same code that the customer system signed. The customer's digital signature is invalid, for example, if a malicious actor tampered with the code at some point after the customer system signed the code. Tampering with the code would change the output of the hash function so that it does not match the hash code in the digital signature. If the attempt to validate the digital signature fails, then the digital signature is not valid.

In an embodiment, if the customer did not approve the signed code, the provider system halts the deployment (Operation 222). Halting the deployment causes the provider system to refrain from performing further operations that would advance the deployment. Alternatively, or additionally, the provider system generates a message in a log file and/or user interface indicating that the deployment is halted. The message include a reason, i.e., one or more tags, natural language sentences, etc. indicating that the customer did not approve the signed code. In an embodiment, responsive to the message, the provider initiates a root cause investigation into the operations that resulted in the customer not approving the signed code.

In an embodiment, if the provider's digital signature is valid, the provider system prepares a deployment package (Operation 224). The deployment package is a logical wrapper around the double-signed code. The wrapper is a data structure configured to store the double-signed code and metadata associated with the deployment (e.g., a target directory, user credentials, etc.). In an embodiment, the provider system applies another digital signature to the deployment package itself. If the code was already double-signed and the provider system applies another digital signature to the deployment package, the code is now triple-signed. If the customer system did not apply the customer's digital signature to the signed code, then the code is now double-signed by the provider system, in which case operations described herein that refer to triple-signed code apply to the double-signed code instead.

In an embodiment, the provider system transmits the deployment package to the target environment (Operation 226). In this example, the target environment is an ILOM. The provider system transmits the triple-signed code to the ILOM over a network connection to the service processor. In an embodiment, the service processor allows deployments only through a particular network port, with that network port being passable only with the appropriate credentials.

In an embodiment, the system determines if the deployment package in the target environment is valid (Operation 228). The system determines if the deployment package is valid by attempting to validate the provider's digital signature. An invalid signature indicates that the deployment package is not the same deployment package that the provider system signed. The provider's digital signature is invalid, for example, if a malicious actor tampered with the deployment package after the provider system digitally signed the deployment package. Tampering with the signed deployment package would change the output of the hash function so that it does not produce the same hash code as the hash code in the digital signature. Thus, the validation attempt fails, indicating that the deployment package is not valid.

In an embodiment, if the deployment package in the target environment is not valid, the provider system halts deployment (Operation 230). Halting the deployment causes the provider system to refrain from performing further operations that would advance the deployment. Alternatively, or additionally, the provider system generates a message in a log file and/or user interface indicating that the deployment is halted. The message includes a reason, i.e., one or more tags, natural language sentences, etc. indicating that the deployment package is not valid. In an embodiment, responsive to the message, the provider initiates a root cause investigation into the operations that resulted in the deployment package being invalid.

In an embodiment, if the deployment package in the target environment is valid, the provider system or customer system determines if the customer approved the code (Operation 232). To determine if the customer approved the code, the provider system or customer system attempts to validate the customer's digital signature applied to the double-signed code using the customer's public key. An invalid signature indicates that the code in the deployment package is not the same code that the customer system signed. The customer's digital signature is invalid, for example, if a malicious actor tampered with the code at some point after the customer system signed the code. Tampering with the code would change the output of the hash function so that it does not match the hash code in the digital signature. In this example, if the attempt to validate the digital signature fails, then the customer's digital signature is not valid and the customer did not approve the code in the deployment package.

In an embodiment, if the customer did not approve the deployment package, the provider system halts deployment (Operation 234). Halting the deployment causes the provider system to refrain from performing further operations that would advance the deployment. Alternatively, or additionally, the provider system generates a message in a log file and/or user interface indicating that the deployment is halted. The message include a reason, i.e., one or more tags, natural language sentences, etc. indicating that the customer did not approve the deployment package. In an embodiment, responsive to the message, the provider initiates a root cause investigation into the operations that resulted in the customer not approving the deployment package.

In an embodiment, if the customer approved the deployment package, the provider system installs the code (Operation 236). To install the code, the provider system extracts the code from the deployment package and stores the code at the appropriate location(s) in the ILOM's storage system. In one example, the provider system stores Python scripts at appropriate locations in a file system hierarchy. One or more embodiments define the location(s) in which to store code in metadata accompanying the deployment package.

In an embodiment, the customer system performs one or more post-deployment validations of the deployed code and determines if the validation passed (Operation 238). The provider system leaves an encrypted copy of the code in the ILOM. The customer system accesses the ILOM, extracts the code from the encrypted copy, and compares the extracted code with the code deployed on the ILOM. The validation passes if the two sets of code match. If the two sets of code do not match, then the code deployed on the ILOM has been modified from what the customer approved.

In an embodiment, if the validation did not pass, the customer system takes remedial action (Operation 240). Remedial action takes one or more of various possible forms. In an embodiment, remedial action rolls back the state of the ILOM software and/or firmware to a version that preceded the deployment. Alternatively, or additionally, the provider system generates a message in a log file and/or user interface indicating that the deployed code has been altered. The message include a reason, i.e., one or more tags, natural language sentences, etc. indicating that the deployed code has been altered. In an embodiment, responsive to the message, the provider initiates a root cause investigation into the operations that resulted in the deployed code being altered.

In an embodiment, the customer system continues to perform post-deployment validations on an ongoing basis. Specifically, the customer system performs post-deployment validations periodically, at predefined intervals, and/or responsive to detecting a triggering event (e.g., a reboot, an instruction received from the customer system, etc.). Post-deployment validations further improve trust by allowing the customer system to confirm that the code was not altered post-deployment.

### 4. Operations For Post-Deployment Code Validation

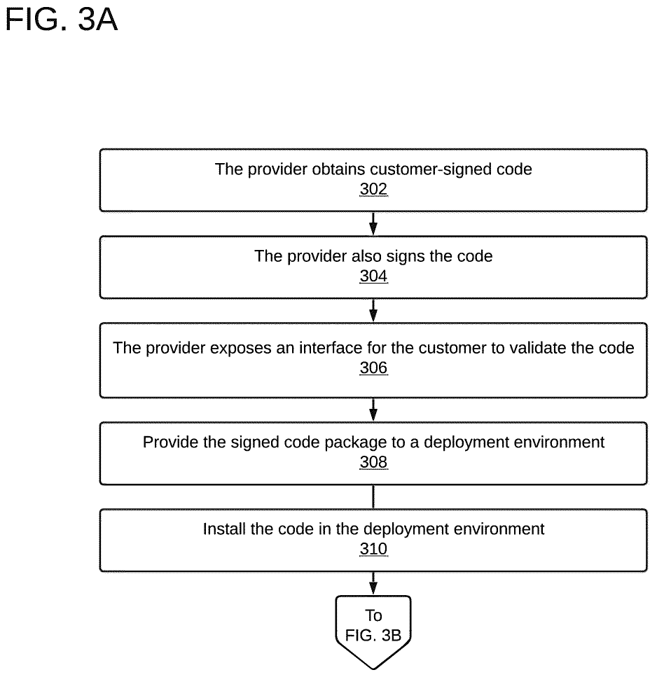

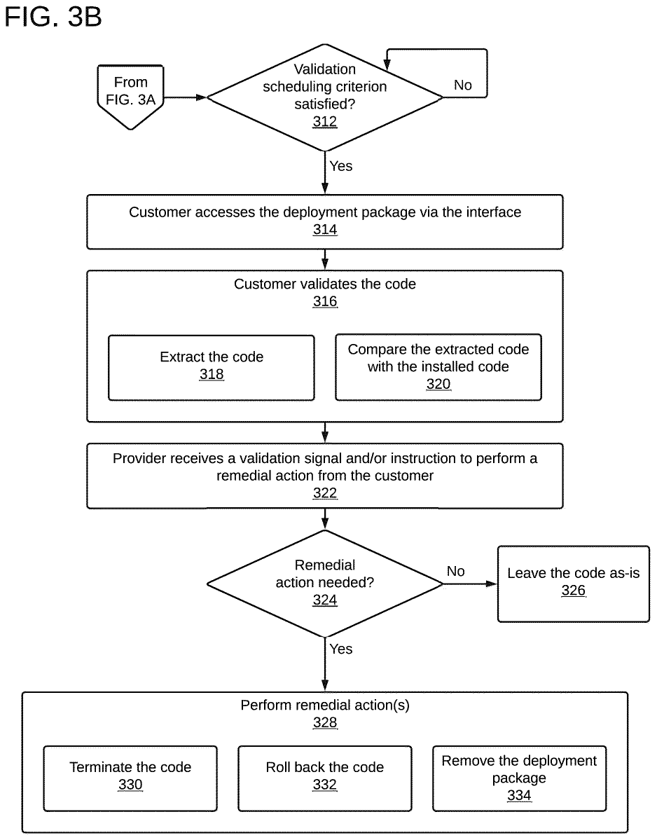

FIGS. 3A-3B illustrate an example set of operations for post-deployment code validation in accordance with one or more embodiments. One or more operations illustrated in FIGS. 3A-3B may be modified, rearranged, or omitted. Accordingly, the particular sequence of operations illustrated in FIGS. 3A-3B should not be construed as limiting the scope of one or more embodiments.

In an embodiment, the provider obtains customer-signed code (Operation 302). The provider makes the code available to the customer in a shared repository. In an embodiment, the provider prepares the code by generating a compressed file (e.g., a zip file) that includes the code file(s) and makes the compressed file available to the customer in the shared repository. The customer accesses the shared repository and applies the customer's digital signature to the code (e.g., to the zip file). The customer stores the customer-signed code in the shared repository. The provider obtains the customer-signed code from the shared repository.

In an embodiment, the provider also signs the code (Operation 304). Specifically, the provider system uses a private key associated with the provider to apply the provider's digital signature to the code. If the code is compressed in a zip file, the provider system applies the provider's digital signature to the zip file. In this example, the provider system digitally signs the code after the customer system digitally signs the code. In another embodiment, the customer system digitally signs the code before the provider system digitally signs the code. In another embodiment, the customer's digital signature is optional.

In an embodiment, the provider exposes an interface for the customer to validate the code (Operation 306). In one example, the interface is a REST interface. The provider operates a service that exposes one or more endpoints of the REST interface. The provider issues one or more API key(s) to the customer that allow(s) the customer to make API calls to the REST interface. In an embodiment, the provider exposes the interface in the deployment environment (e.g., an ILOM). Alternatively, or additionally, the provider exposes the interface in a middleware server and/or other location in the provider system.

In an embodiment, the provider provides the signed code package to a deployment environment (Operation 308). Specifically, the provider prepares a deployment package and provides the deployment package to the deployment environment. In one example, the deployment environment is an ILOM. The provider pushes the signed code package to a middleware server. A middleware agent operating on the ILOM accesses the middleware server and creates a copy of the signed code package on the ILOM.

In an embodiment, the provider installs the code in the deployment environment (Operation 310). To install the code, the provider system extracts the code from the deployment package and stores the code at the appropriate location(s) in the ILOM's storage system. In one example, the provider system stores Python scripts at appropriate locations in a file system hierarchy. One or more embodiments define the location(s) in which to store code in metadata accompanying the deployment package.

In an embodiment, the system determines if a validation scheduling criterion is satisfied (Operation 312). This determination is performed by the provider system or the customer system, depending on which system is responsible for monitoring validation scheduling criteria. A validation scheduling criterion determines when to perform a post-deployment code validation. Specifically, the validation scheduling criterion indicates that code validation should occur periodically, at predefined intervals, and/or responsive to detecting a triggering event (e.g., a reboot, an instruction received from the customer system, etc.). In an embodiment, if a validation scheduling criterion is not satisfied, the system does not perform post-deployment code validation until a validation scheduling criterion is satisfied. If a validation scheduling criterion is satisfied, the system proceeds to perform a post-deployment code validation.

In an embodiment, the customer accesses the deployment package via the validation interface (Operation 314). In one example, the validation interface is a REST API. The customer makes an API call to the validation interface, requesting access to the deployment package. If the API call is valid (e.g., the customer supplies a valid API key), the provider grants access to the deployment package.

In an embodiment, the customer validates the code (Operation 316). Validating the code determines if the code installed in the deployment environment matches what the customer signed before the deployment. To validate the code, the customer extracts the code (Operation 318). Extracting the code provides uncompressed copies of the code file(s) and other artifacts included in the deployment package. The customer compares the newly extracted code with the installed code (Operation 320). If the code is in a declarative language (e.g., Python), the customer performs a line-by-line comparison of the newly extracted code with the installed code. If the installed code is compiled code, the customer compiles the newly extracted code and compares the compiled executable file(s) with the installed executable file(s). Comparing compiled code is easier if the environments in which the executable file(s) was/were compiled are heterogenous (e.g., virtual machines running heterogeneous builds) because the code compiles to identical executable file(s). In an embodiment, the customer also compares non-code artifacts in the deployment package with artifacts installed on the ILOM.

In an embodiment, the provider receives, from the customer, a validation signal and/or an instruction to perform a remedial action (Operation 322). The validation signal indicates if the installed code is valid, i.e., matches what the customer signed. The validation signal includes a code, message, and/or other data indicating if the installed code is valid. Alternatively, or additionally, an instruction to perform a remedial action indicates that the installed code is not valid. In an embodiment, the instruction indicates what sort(s) of remedial action(s) to perform, such as terminating the code, rolling back the code, and/or removing the deployment package from the ILOM.

In an embodiment, based at least in part on the signal and/or instruction received from the customer, the provider determines if a remedial action is needed (Operation 324). If the provider receives a validation signal, the provider inspects the validation signal to determine if the code, message, and/or other data in the validation signal indicates that the installed code is valid. Alternatively, or additionally, an instruction to perform one or more remedial actions indicates that the installed code is not valid.

In an embodiment, if no remedial action is needed, the provider leaves the code as-is (Operation 326). Because the installed code matches what the customer signed, the code can remain installed and operational on the ILOM. The code remains installed and operational until some other condition arises (e.g., a server shutdown, an upgrade, etc.) that requires the code to be taken offline, upgraded, or otherwise modified or removed from the ILOM.

In an embodiment, if a remedial action is needed, the provider performs one or more remedial actions (Operation 328). In general, a remedial action is an action that remediates the presence of invalid code, to protect against potential unexpected and/or malicious behaviors introduced by code that does not match the code the customer signed. A remedial action protects against future harm to ILOM performance and/or security. In an embodiment, a remedial action restores the ILOM to a prior valid state.

In an embodiment, a remedial action terminates the code (Operation 330). Specifically, if the code is an executable file, the remedial action terminates a running instance of the executable. In one example, the code is an executable file corresponding to a background process, so the remedial action terminates the background process. Terminating the code ensures that malformed and/or malicious parts of the code do not have further opportunities to impede system performance and/or compromise security.

In an embodiment, a remedial action rolls back the code (Operation 332). The system accesses a code backup corresponding to a prior valid state and deploys the backup on the ILOM. If the ILOM includes other code that depends on the code being rolled back, the remedial action also rolls back the other code or otherwise resolves the dependency issue. In an embodiment, if one or more dependencies prevent a rollback, the system generates an alert for a human operator to address the failed rollback.

In an embodiment, a remedial action removes the deployment package from the ILOM (Operation 334). Removing the deployment package deletes the deployment package, so the invalid code cannot be extracted again on the ILOM. Alternatively, or additionally, a remedial action quarantines the deployment package, so it cannot be extracted but remains available for inspection by a root cause analysis and/or auditor.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

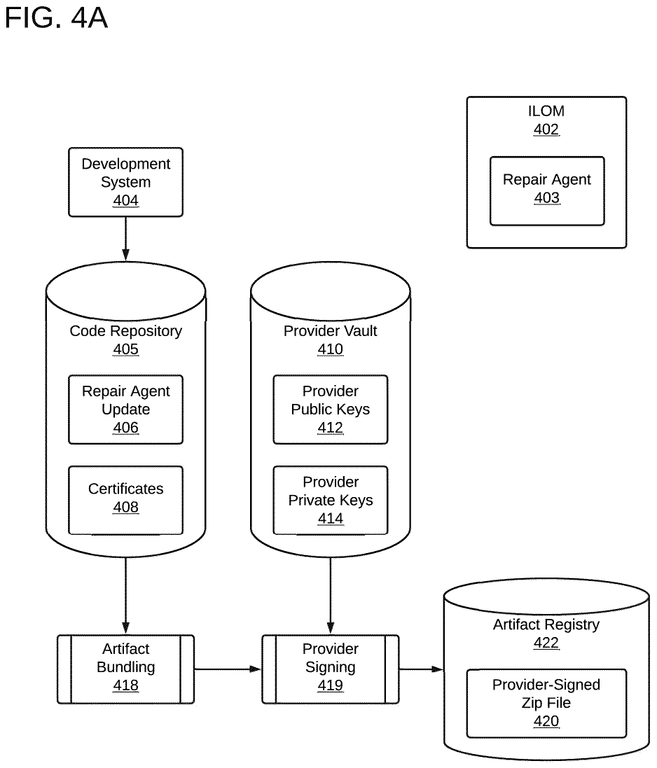

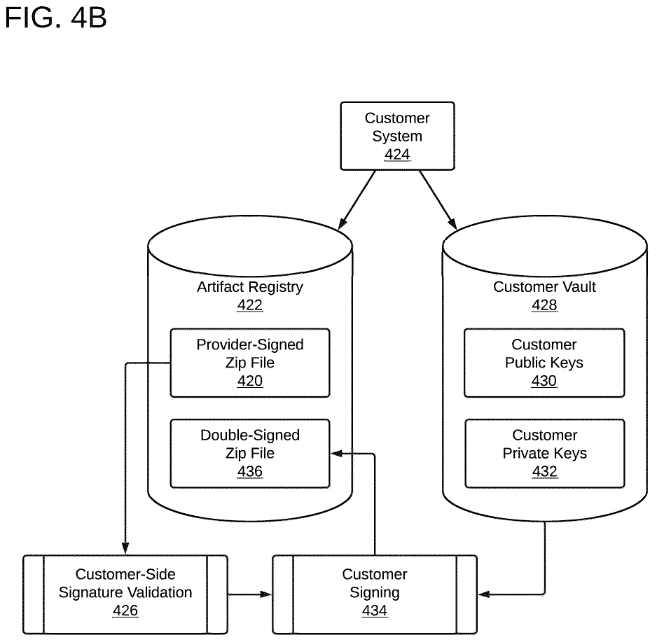

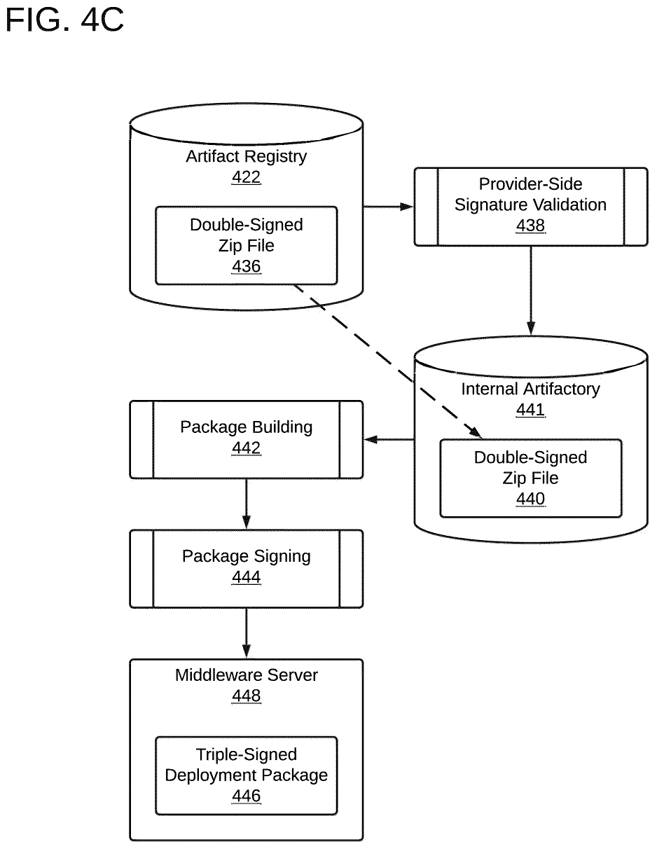

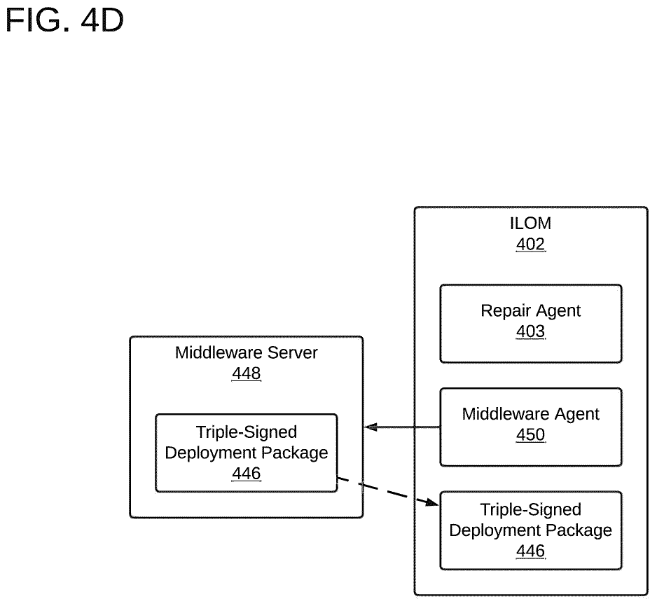

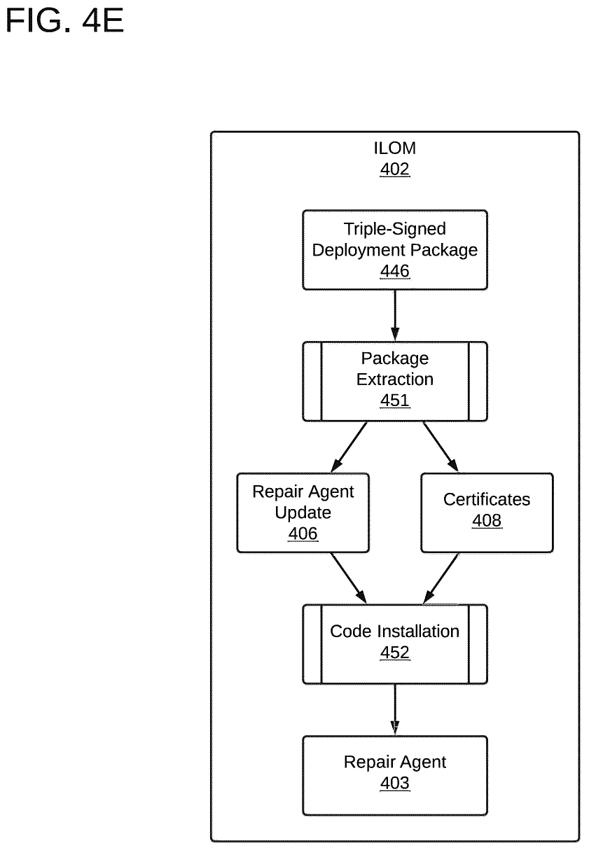

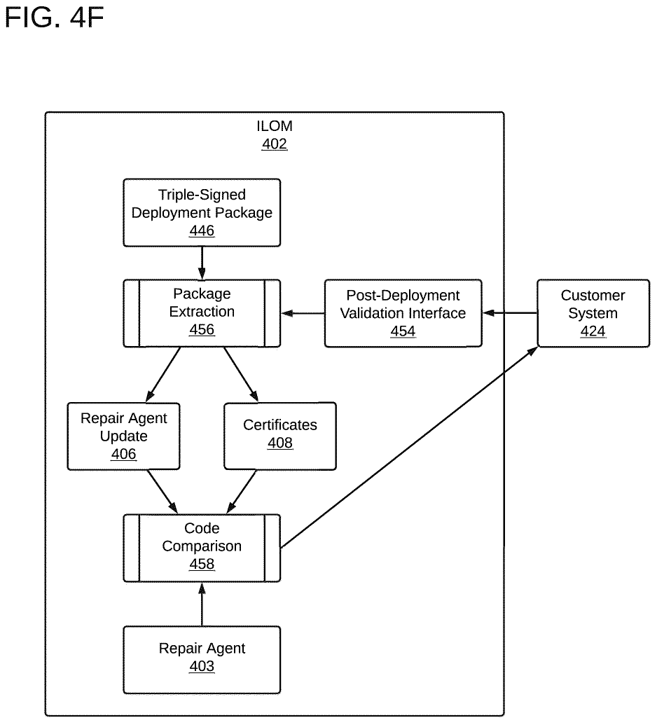

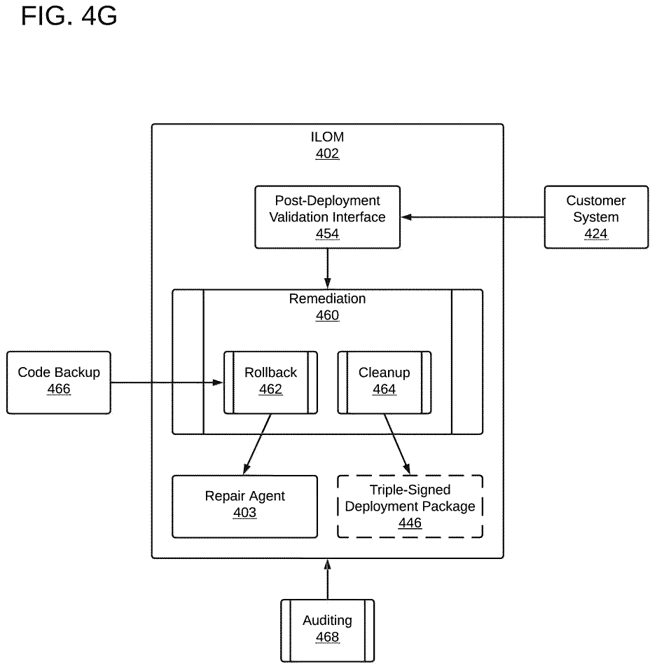

Specifically, FIGS. 4A-4G illustrate an example of mutually trusted code deployment and post-deployment code validation in accordance with one or more embodiments. In this example, a provider hosts ILOM 402 on behalf of a customer. ILOM 402 includes repair agent 403. Repair agent 403 is responsible, in part, for managing, recording, and verifying hardware repairs on the server associated with ILOM 402. The provider and customer seek to upgrade repair agent 403 using mutually trusted code deployment.

As shown in FIG. 4A, development system 404 stores code in code repository 405. Specifically, development system 404 stores repair agent update 406 in code repository 405. Development system 404 also stores certificates 408 in code repository 405. Certificates 408 are certificates needed to operate repair agent 403 when repair agent update 406 has been deployed.

As part of deploying repair agent update 406, the system performs artifact bundling 418. Specifically, the system generates a bundle that includes repair agent update 406 and the associated certificates 408. The bundle is a zip file that includes the artifacts.

Provider vault 410 is a data repository under the provider's control. Provider vault 410 includes the provider's public keys 412 and private keys 414. The provider also has access to the customer's public key(s), not shown in FIG. 4A. The provider uses one of the provider's public keys 414 to perform provider signing 419, producing provider-signed zip file 420. The provider stores provider-signed zip file 420 in artifact registry 422. Artifact registry 422 is a repository that manages code and related artifacts such as GitHub.

As shown in FIG. 4B, customer system 424 also has access to artifact registry 422. Customer system 424 monitors artifact registry 422 for pull requests (e.g., merging code into a branch intended for deployment). In response to detecting a pull request, customer system 424 accesses the provider-signed zip file 420 and performs customer-side signature validation 426. Specifically, customer system 424 uses the provider's public key, corresponding to the private key used to sign the code, to validate the provider's signature.

In this example, customer-side signature validation 426 passes, and the deployment process proceeds. As shown in FIG. 4B, customer vault 428 is a data repository, under the customer's control, that includes the customer's public keys 430 and private keys 432. Customer system 424 uses a private key 432 to perform customer signing 434, i.e., digitally sign the code, resulting in a double-signed zip file 436. Customer system 424 stores double-signed zip file 436 in artifact registry 422.

As shown in FIG. 4C, the provider accesses double-signed zip file 436 and performs provider-side signature validation 438. Provider-side signature validation 438 validates both the provider's signature and the customer's signature on double-signed zip file 436. In this example, both signatures are valid. The provider stores double-signed zip file 440 in an internal (to the provider system) artifactory 441. Internal artifactory 441 serves as a staging location for package building 442 and package signing 444. Package building 442 generates a deployment package. Package signing 444 applies another digital signature associated with the provider. The provider's second digital signature uses a different private key 414 than the one used to sign provider-signed zip file 420. The provider transmits the resulting triple-signed deployment package 446 to middleware server 448. Middleware server 448 serves as a staging area for transmitting triple-signed deployment package 446 to ILOM 402.

As shown in FIG. 4D, ILOM 402 includes middleware agent 450. Middleware agent 450 communicates with middleware server 448 to provide a copy of triple-signed deployment package 446 to ILOM 402. As shown in FIG. 4E, the provider performs package extraction 451 to extract repair agent update 406 and the associated certificates 408 on ILOM 402. The provider performs code installation 452 to install repair agent update 406. Installing repair agent update 406 modifies, removes, and/or replaces code associated with repair agent 403, effectively upgrading repair agent 403 to a version consistent with repair agent update 406.

As shown in FIG. 4F, the system performs post-deployment code validation. ILOM 402 includes post-deployment validation interface 454, which is a REST API. Customer system 424 makes an API call to post-deployment validation interface 454, requesting validation of the code installed on ILOM 402. In response to the API call, the system performs package extraction 456, producing copies of repair agent update 406 and certificates 408. Customer system 424 performs a code comparison 458 of the newly extracted repair agent update 406 with the installed version of repair agent 403. Because repair agent update 406 has already been installed at this point, code comparison 458 should indicate that the newly extracted repair agent update 406 matches repair agent 403.

In this example, the newly extracted repair agent update 406 does not match repair agent 403, indicating that the installed code does not match what the customer signed. As shown in FIG. 4G, customer system 424 makes another API call to post-deployment validation interface 454 with an instruction to remediate the mismatch. Alternatively, the prior API call included information about what remediation action(s) to perform in the event of a mismatch.

Referring still to FIG. 4G, in response to customer system 424's instruction, the system performs remediation 460. In this example, remediation 460 includes a rollback 462. The system accesses a prior valid version of repair agent 403 from code backup 466 and installs the prior valid version as repair agent 403. Installing the prior valid version overwrites the invalid version. In addition, in this example, remediation 460 performs cleanup 464. Cleanup 464 removes triple-signed deployment package 446 from ILOM 402, protecting against future attempts to extract and install the invalid code.

Before, during, and/or after deploying repair agent update 406 and/or performing post-deployment code validation, the system performs auditing 468. In this example, auditing 468 is an automated process that monitors, collects, and/or analyzes system activity. Auditing 468 verifies that the system complies with security, operational, and/or regulatory requirements without requiring manual human review of the relevant event(s) and/or configuration(s). Here, auditing 468 generates an audit trail, including information about the parties' digital signatures, dates and times when deployment, validation, and/or remediation events occurred, etc. Auditing 468 supports root cause analysis to help determine how a mismatch between repair agent update 406 and repair agent 403 occurred.

### 6. Practical Applications, Advantages, and Improvements

Embodiments provide several practical applications, advantages, and improvements over existing approaches. These advantages and improvements include the following:
1. Improved system performance. Unsanctioned code can degrade system performance. In one example, unsanctioned code hijacks system resources, such as processor cycles, memory, network bandwidth, etc., degrading the performance of other processes that rely on those resources. One or more embodiments improve system performance by preventing the deployment of unsanctioned code that might otherwise degrade system performance.
2. Improved system security. Unsanctioned code can compromise system security by disabling or modifying a critical service, such as a credential database or a firewall. Alternatively, or additionally, unsanctioned code may copy, delete, and/or modify customer data, resulting in data loss and/or data theft. One or more embodiments improve system security by preventing the deployment of unsanctioned code that might otherwise compromise system security.
3. Improved root cause analysis. When a system does not perform as expected, root cause analysis leverages log files, system traces, etc., to determine the underlying cause(s) of the performance issue(s). One or more embodiments improve root cause analysis by providing verifiable evidence, in the form of the customer's digital signature, that the customer approved the code for deployment.

Operations described herein for mutually trusted code deployment are inherently tied to a computer system and are not capable of being performed by a human. For example, due to the complexity of digital signing algorithms needed to make digital signatures secure, a human is not realistically capable of digitally signing data or validating digital signatures. By some estimates, it would take a human longer than the age of the universe to perform a Secure Hash Algorithm 256-bit (SHA-256) calculation by hand. In addition, because a human is not capable of manipulating bits in memory or communicating with a network interface, a human is not capable of packaging digitally signed code, transmitting the package to a target environment, or installing the code.

### 7. Examples of Cloud Infrastructure

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

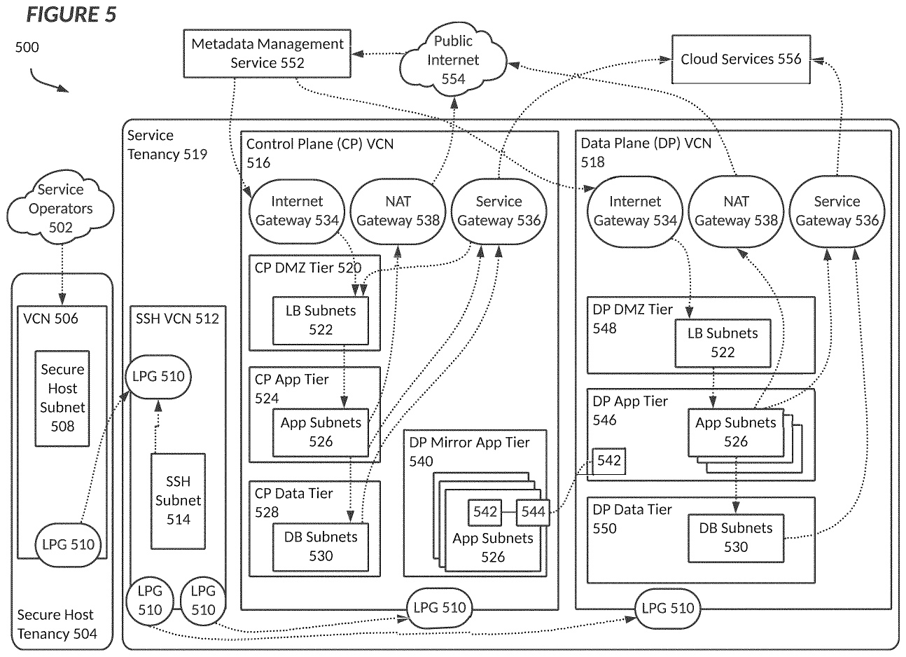

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 implemented in the SSH VCN 512. The SSH VCN 512 can include an SSH subnet 514, and the SSH VCN 512 can be communicatively coupled to a control plane VCN 516 via the LPG 510 implemented in the control plane VCN 516. Also, the SSH VCN 512 can be communicatively coupled to a data plane VCN 518 via an LPG 510. The control plane VCN 516 and the data plane VCN 518 can be implemented in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 in the control plane DMZ tier 520 can be communicatively coupled to the app subnet(s) 526 in the control plane app tier 524 and an Internet gateway 534 that can be implemented in the control plane VCN 516. The app subnet(s) 526 can be communicatively coupled to the DB subnet(s) 530 implemented in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 implemented in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be implemented in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way; the service gateway 536 can make API calls to cloud services 556, and cloud services 556 can send requested data to the service gateway 536. However, cloud services 556 may not initiate API calls to the service gateway 536.

In some examples, the secure host tenancy 504 can be directly connected to the service tenancy 519. The service tenancy 519 may otherwise be isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision resources. Resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be implemented in the data plane mirror app tier 540 and the data plane app tier 546.

In some examples, users or customers, of the system, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 implemented in the control plane DMZ tier 520. The LB subnet(s) 522 may determine that the request is valid, and in response, the LB subnet(s) 522 can transmit the request to app subnet(s) 526 implemented in the control plane app tier 524. If the request is validated and requires a call to public Internet 554, the call to public Internet 554 may be transmitted to the NAT gateway 538 that can make the call to public Internet 554. Metadata to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to a configuration may need to be applied to the resources implemented in the data plane VCN 518. Via a VNIC 542, the control plane VCN 516 can directly communicate with, and can thereby execute the changes, updates, or other suitable modifications to configuration to, resources implemented in the data plane VCN 518.

In some embodiments, the control plane VCN 516 and the data plane VCN 518 can be implemented in the service tenancy 519. In this case, the user, or the customer, of the system may not own or operate either the control plane VCN 516 or the data plane VCN 518. Instead, the IaaS provider may own or operate the control plane VCN 516 and the data plane VCN 518. The control plane VCN 516 and the data plane VCN 518 may be implemented in the service tenancy 519. This embodiment can enable isolation of networks that may prevent users or customers from interacting with other users', or other customers', resources. Also, this embodiment may allow users, or customers, of the system to store databases privately without needing to rely on public Internet 554, that may not have a sufficient level of threat protection, for storage.

In other embodiments, the LB subnet(s) 522 implemented in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may need this embodiment since database(s) that the customers use may be controlled by the IaaS provider and may be stored on the service tenancy 519. The service tenancy 519 may be isolated from public Internet 554.

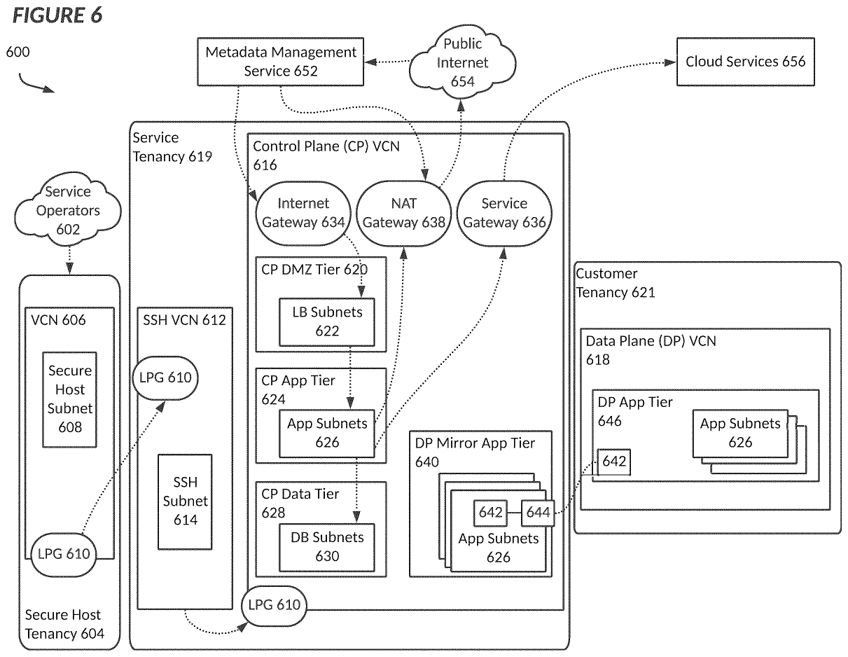

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 610 implemented in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 implemented in the control plane VCN 616. The control plane VCN 616 can be implemented in a service tenancy 619 (e.g., the service tenancy 519 of FIG. 5), and the data plane VCN 618 (e.g., the data plane VCN 518 of FIG. 5) can be implemented in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), and a control plane data tier 628 (e.g., the control plane data tier 528 of FIG. 5) that can include database (DB) subnet(s) 630 (e.g., similar to DB subnet(s) 530 of FIG. 5). The LB subnet(s) 622 implemented in the control plane DMZ tier 620 can be communicatively coupled to the app subnet(s) 626 implemented in the control plane app tier 624 and an Internet gateway 634 (e.g., the Internet gateway 534 of FIG. 5) that can be implemented in the control plane VCN 616. The app subnet(s) 626 can be communicatively coupled to the DB subnet(s) 630 implemented in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 implemented in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be implemented in a data plane app tier 646 (e.g., the data plane app tier 546 of FIG. 5). The compute instance 644 can facilitate this communication via the VNIC 642 implemented in the data plane mirror app tier 640 and the VNIC 642 implemented in the data plane app tier 646.

The Internet gateway 634 implemented in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 implemented in the control plane VCN 616. The service gateway 636 implemented in the control plane VCN 616 can be communicatively couple to cloud services 656 (e.g., cloud services 556 of FIG. 5).

In some examples, the data plane VCN 618 can be implemented in the customer tenancy 621. In this case, the IaaS provider may provide the control plane VCN 616 for a customer, and the IaaS provider may, for a customer, set up a unique, compute instance 644 that is implemented in the service tenancy 619. A compute instance 644 may allow communication between the control plane VCN 616 implemented in the service tenancy 619 and the data plane VCN 618 that is implemented in the customer tenancy 621. The compute instance 644 may allow resources provisioned in the control plane VCN 616 that is implemented in the service tenancy 619 to be deployed or otherwise used in the data plane VCN 618 that is implemented in the customer tenancy 621.

In other examples, the customer of the IaaS provider may have databases that are implemented in the customer tenancy 621. In this example, the control plane VCN 616 can include the data plane mirror app tier 640 that can include app subnet(s) 626. The data plane mirror app tier 640 can be implemented in the control plane VCN 616, but the data plane mirror app tier 640 may not be implemented in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity implemented in the control plane VCN 616. The customer may need to deploy or otherwise use resources in the data plane VCN 618 that are provisioned in the control plane VCN 616, and the data plane mirror app tier 640 can facilitate the deployment or other usage of resources of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, implemented in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be active or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 1” may be located in Region 1 and in “Region 2.” If a call to Deployment 1 is made by the service gateway 636 implemented in the control plane VCN 616 located in Region 1, the call may be transmitted to Deployment 1 in Region 1. In this example, the control plane VCN 616, or Deployment 1 in Region 1, may not be communicatively coupled to, or otherwise in communication with, Deployment 1 in Region 2.

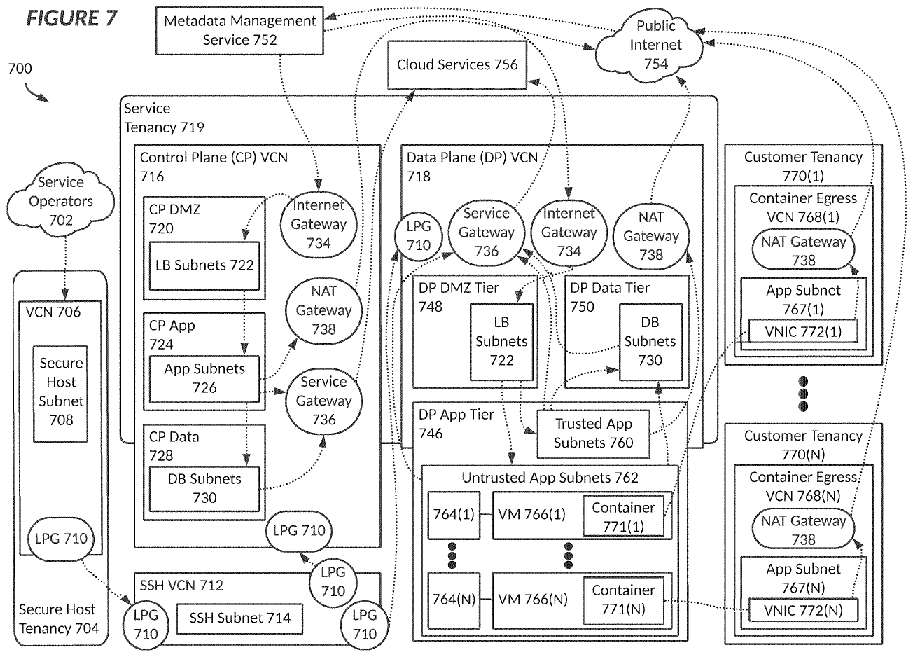

FIG. 7 is a block diagram 300 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 implemented in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 implemented in the control plane VCN 716 and to a data plane VCN 718 (e.g., the data plane VCN 518 of FIG. 5) via an LPG 710 implemented in the data plane VCN 718. The control plane VCN 716 and the data plane VCN 718 can be implemented in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), and a control plane data tier 728 (e.g., the control plane data tier 528 of FIG. 5) that can include DB subnet(s) 730. The LB subnet(s) 722 implemented in the control plane DMZ tier 720 can be communicatively coupled to the app subnet(s) 726 implemented in the control plane app tier 724 and to an Internet gateway 734 (e.g., the Internet gateway 534 of FIG. 5) that can be implemented in the control plane VCN 716, and the app subnet(s) 726 can be communicatively coupled to the DB subnet(s) 730 implemented in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760, untrusted app subnet(s) 762 of the data plane app tier 746, and the Internet gateway 734 implemented in the data plane VCN 718. The trusted app subnet(s) 760 can be communicatively coupled to the service gateway 736 implemented in the data plane VCN 718, the NAT gateway 738 implemented in the data plane VCN 718, and DB subnet(s) 730 implemented in the data plane data tier 750. The untrusted app subnet(s) 762 can be communicatively coupled to the service gateway 736 implemented in the data plane VCN 718 and DB subnet(s) 730 implemented in the data plane data tier 750. The data plane data tier 750 can include DB subnet(s) 730 that can be communicatively coupled to the service gateway 736 implemented in the data plane VCN 718.

The untrusted app subnet(s) 762 can include one or more primary VNICs 764(1)-(N) that can be communicatively coupled to tenant virtual machines (VMs) 766(1)-(N). Tenant VMs 766(1)-(N) can be communicatively coupled to a respective app subnets 767(1)-(N) that can be implemented in respective container egress VCNs 768(1)-(N) that can be implemented in respective customer tenancies 770(1)-(N). Respective secondary VNICs 772(1)-(N) can facilitate communication between the untrusted app subnet(s) 762 implemented in the data plane VCN 718 and the app subnet implemented in the container egress VCNs 768(1)-(N). Container egress VCNs 768(1)-(N) can include a NAT gateway 738 that can be communicatively coupled to public Internet 754 (e.g., public Internet 554 of FIG. 5).

The Internet gateway 734 implemented in the control plane VCN 716 and implemented in the data plane VCN 718 can be communicatively coupled to a metadata management service 752 (e.g., the metadata management service 552 of FIG. 5) that can be communicatively coupled to public Internet 754. Public Internet 754 can be communicatively coupled to the NAT gateway 738 implemented in the control plane VCN 716 and implemented in the data plane VCN 718. The service gateway 736 implemented in the control plane VCN 716 and implemented in the data plane VCN 718 can be communicatively couple to cloud services 756.

In some embodiments, the data plane VCN 718 can be integrated with customer tenancies 770(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 746. Code to execute the function may be executed in the VMs 766(1)-(N), and the code may not be configured to execute anywhere else on the data plane VCN 718. VMs 766(1)-(N) may be connected to one customer tenancy 770(1). Respective containers 771(1)-(N) implemented in the VMs 766(1)-(N) may be configured to execute the code. In this case, there can be a dual isolation (e.g., the containers 771(1)-(N) executing code), where the containers 771(1)-(N) may be implemented in at least the VM 766(1)-(N) that are implemented in the untrusted app subnet(s) 762) that may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completing execution of the code, the IaaS provider may terminate or otherwise dispose of the containers 771(1)-(N).

In some embodiments, the trusted app subnet(s) 760 may execute code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be implemented in the VM 766(1)-(N) of a customer and that may execute code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

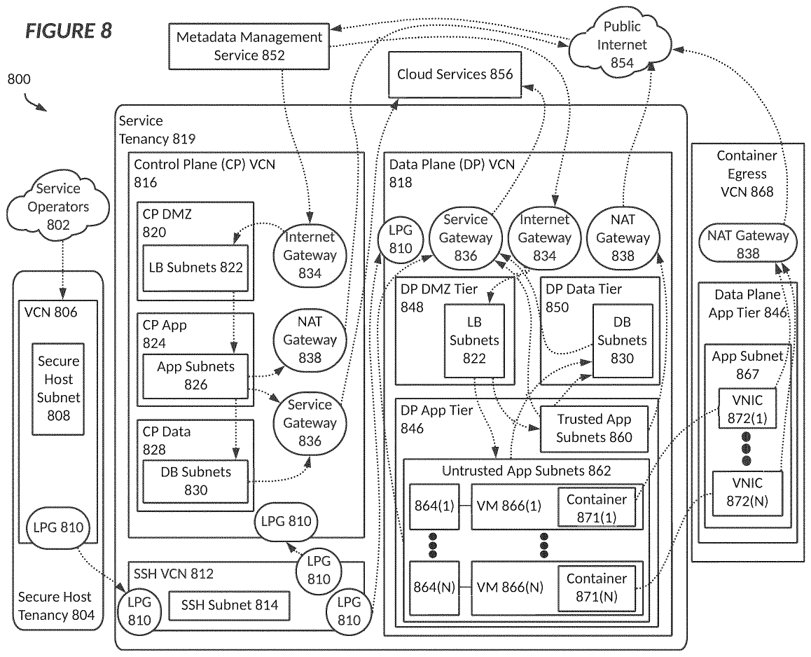

FIG. 8 is a block diagram illustrating another example pattern of an IaaS architecture 800 according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 implemented in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 implemented in the control plane VCN 816 and to a data plane VCN 818 (e.g., the data plane VCN 518 of FIG. 5) via an LPG 810 implemented in the data plane VCN 818. The control plane VCN 816 and the data plane VCN 818 can be implemented in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), and a control plane data tier 828 (e.g., the control plane data tier 528 of FIG. 5) that can include DB subnet(s) 830 (e.g., DB subnet(s) 730 of FIG. 7). The LB subnet(s) 822 implemented in the control plane DMZ tier 820 can be communicatively coupled to the app subnet(s) 826 implemented in the control plane app tier 824 and to an Internet gateway 834 (e.g., the Internet gateway 534 of FIG. 5) that can be implemented in the control plane VCN 816, and the app subnet(s) 826 can be communicatively coupled to the DB subnet(s) 830 implemented in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 implemented in the data plane VCN 818. The trusted app subnet(s) 860 can be communicatively coupled to the service gateway 836 implemented in the data plane VCN 818, the NAT gateway 838 implemented in the data plane VCN 818, and DB subnet(s) 830 implemented in the data plane data tier 850. The untrusted app subnet(s) 862 can be communicatively coupled to the service gateway 836 implemented in the data plane VCN 818 and DB subnet(s) 830 implemented in the data plane data tier 850. The data plane data tier 850 can include DB subnet(s) 830 that can be communicatively coupled to the service gateway 836 implemented in the data plane VCN 818.

The untrusted app subnet(s) 862 can include primary VNICs 864(1)-(N) that can be communicatively coupled to tenant virtual machines (VMs) 866(1)-(N) implemented within the untrusted app subnet(s) 862. Tenant VMs 866(1)-(N) can execute code in a respective container 867(1)-(N) and be communicatively coupled to an app subnet 867 that can be implemented in a data plane app tier 846 that can be implemented in a container egress VCN 868. Respective secondary VNICs 872(1)-(N) can facilitate communication between the untrusted app subnet(s) 862 implemented in the data plane VCN 818 and the app subnet 867 implemented in the container egress VCN 868. The container egress VCN 868 can include a NAT gateway 838 that can be communicatively coupled to public Internet 854 (e.g., public Internet 554 of FIG. 5).

The Internet gateway 834 implemented in the control plane VCN 816 and implemented in the data plane VCN 818 can be communicatively coupled to a metadata management service 852 (e.g., the metadata management service 552 of FIG. 5) that can be communicatively coupled to public Internet 854. Public Internet 854 can be communicatively coupled to the NAT gateway 838 implemented in the control plane VCN 816 and implemented in the data plane VCN 818. The service gateway 836 implemented in the control plane VCN 816 and implemented in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be needed for a customer of the IaaS provider if the IaaS provider cannot directly communicate with the customer (e.g., a disconnected region). The respective containers 871(1)-(N) that are implemented in the VMs 866(1)-(N) for a customer can be accessed in real-time by the customer. The containers 871(1)-(N) may be configured to make calls to respective secondary VNICs 872(1)-(N) implemented in app subnet(s) 867 of the data plane app tier 846 that can be implemented in the container egress VCN 868. The secondary VNICs 872(1)-(N) can transmit the calls to the NAT gateway 838 that may transmit the calls to public Internet 854. In this example, the containers 871(1)-(N) that can be accessed in real time by the customer can be isolated from the control plane VCN 816 and can be isolated from other entities implemented in the data plane VCN 818. The containers 871(1)-(N) may also be isolated from resources from other customers.

In other examples, the customer can use the containers 871(1)-(N) to call cloud services 856. In this example, the customer may execute code in the containers 871(1)-(N) that request a service from cloud services 856. The containers 871(1)-(N) can transmit this request to the secondary VNICs 872(1)-(N) that can transmit the request to the NAT gateway 838 that can transmit the request to public Internet 854. Public Internet 854 can transmit the request to LB subnet(s) 822 implemented in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, and 800 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Computer System

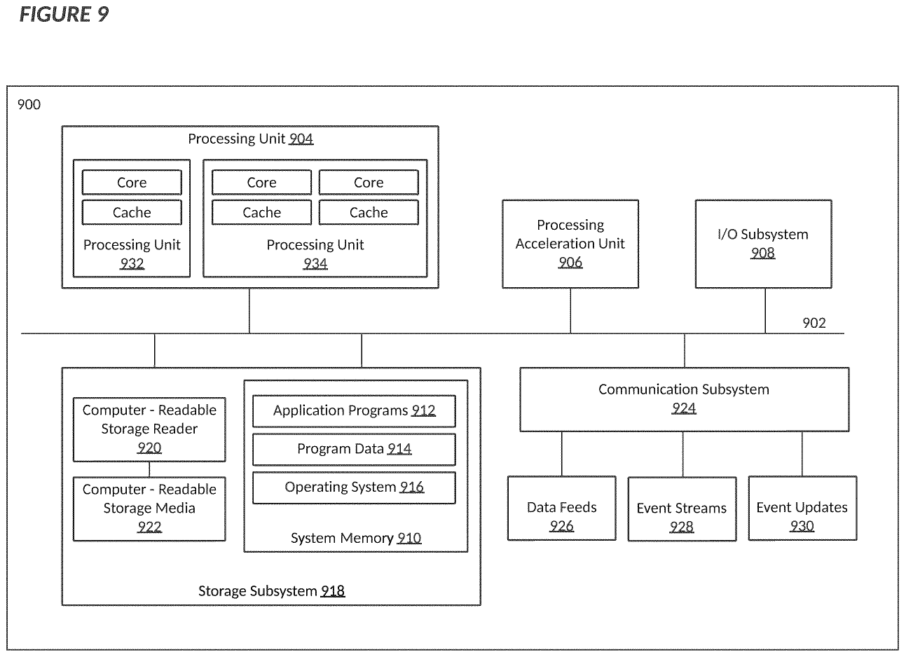

FIG. 9 illustrates an example computer system 900. An embodiment of the disclosure may be implemented upon the computer system 900. As shown in FIG. 9, computer system 900 includes a processing unit 904 that communicates with peripheral subsystems via a bus subsystem 902. These peripheral subsystems may include a processing acceleration unit 906, an I/O subsystem 908, a storage subsystem 918, and a communications subsystem 924. Storage subsystem 918 includes tangible computer-readable storage media 922, computer-readable storage reader 920 and a system memory 910.

Bus subsystem 902 provides a mechanism for letting the various components and subsystems of computer system 900 to communicate with other components and subsystems as intended. Although bus subsystem 902 is shown schematically as a single bus, alternative embodiments of the bus subsystem may utilize multiple buses. Bus subsystem 902 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 904 controls the operation of computer system 900. Processing unit 904 can be implemented as one or more integrated circuits (e.g., a conventional microprocessor or microcontroller). One or more processors may be implemented in processing unit 904. These processors may include single core or multicore processors. In certain embodiments, processing unit 904 may be implemented as one or more independent sub processing units 932 and/or 934 with single or multicore processors implemented in one or more processing units. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, the program code to be executed can be wholly or partially implemented in processing unit 904 and/or in storage subsystem 918. Through suitable programming, processing unit 904 can provide various functionalities described above. Computer system 900 may additionally include a processing acceleration unit 906 that can include a digital signal processor (DSP), a special-purpose processor, and/or the like.

I/O subsystem 908 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 900 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 900 may comprise a storage subsystem 918 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 904, provide the functionality described above. Storage subsystem 918 may also provide a repository for storing data used in accordance with the present disclosure.

As depicted in the example in FIG. 9, storage subsystem 918 can include various components, including a system memory 910, computer-readable storage media 922, and a computer readable storage media reader 920. System memory 910 may store program instructions, such as application programs 912, that are loadable and executable by processing unit 904. System memory 910 may also store data, such as program data 914, that is used during the execution of the instructions and/or data that is generated during the execution of the program instructions. Various programs may be loaded into system memory 910 including, but not limited to, client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 910 may include a basic input/output system (BIOS) including basic routines that help to transfer information between elements within computer system 900 such as during start-up.

Computer-readable storage media 922 may represent remote, local, fixed, and/or removable storage devices plus storage media for temporarily and/or more permanently including and storing computer-readable information for use by computer system 900, including instructions executable by processing unit 904 of computer system 900.

Computer-readable storage media 922 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 900.

Machine-readable instructions executable by one or more processors or cores of processing unit 904 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments, communications subsystem 924 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 924 may be configured to receive data in the form of continuous data streams. The continuous data streams may include event streams 928 of real-time events and/or event updates 930 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in FIG. 9 is intended as a non-limiting example. Many other configurations having more or fewer components than the system depicted in FIG. 9 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
obtaining, by a first entity system from a second entity system, a signed code package comprising a first digital signature applied by the second entity system to a set of code to be deployed to a target computing environment;
exposing, by the first entity system, an interface for the second entity system to validate the first digital signature and communicate a validation signal to the first entity system;
wherein the first digital signature indicates that the set of code satisfies one or more deployment criteria enforced by the second entity system;
wherein validation of the first digital signature, by the second entity system, determines if the set of code in the signed code package has been altered since the second entity system applied the first digital signature to the set of code;
wherein the method is performed by at least one device including a hardware processor.

2. The method of claim 1, further comprising:
providing, by the first entity system, the signed code package to the target computing environment;
wherein the interface exposed by the first entity system allows the second entity system to validate the first digital signature in the target computing environment.

3. The method of claim 2:
wherein the signed code package comprises an unextracted copy of the set of code to be deployed to the target computing environment;
wherein to validate the first digital signature, the second entity system accesses the signed code package in the target computing environment via the interface.

4. The method of claim 2, wherein to validate the first digital signature, the second entity system accesses the first digital signature in the target computing environment via the interface.

5. The method of claim 1, wherein the second entity system validates the first digital signature in the target computing environment before the first entity system finishes deploying the set of code to the target computing environment.

6. The method of claim 1, wherein the second entity system validates the first digital signature in the target computing environment after the first entity system finishes deploying the set of code to the target computing environment.

7. The method of claim 6, further comprising:
receiving, by the first entity system from the second entity system, the validation signal;
determining, by the first entity system, if the validation signal indicates that the first digital signature is valid;
responsive to determining that the validation signal indicates that the first digital signature is not valid: performing, by the first entity system, one or more remedial actions with respect to the set of code deployed to the target computing environment.

8. The method of claim 7, further comprising:
receiving, by the first entity system from the second entity system in association with the validation signal, an instruction to perform the one or more remedial actions with respect to the set of code deployed to the target computing environment;
wherein performing the one or more remedial actions is performed responsive to receiving the instruction to perform the one or more remedial actions.

9. The method of claim 7, wherein performing the one or more remedial actions terminates execution of the set of code in the target computing environment.

10. The method of claim 7, wherein performing the one or more remedial actions removes the set of code from the target computing environment.

11. The method of claim 1, further comprising:
applying, by the first entity system, a second digital signature to the set of code;
wherein the signed code package comprises both the first digital signature applied to the set of code by the second entity system and the second digital signature applied to the set of code by the first entity system.

12. One or more non-transitory computer-readable media storing program instructions that, when executed by one or more hardware processors, cause performance of operations comprising:
obtaining, by a first entity system from a second entity system, a signed code package comprising a first digital signature applied by the second entity system to a set of code to be deployed to a target computing environment;
exposing, by the first entity system, an interface for the second entity system to validate the first digital signature and communicate a validation signal to the first entity system;
wherein the first digital signature indicates that the set of code satisfies one or more deployment criteria enforced by the second entity system;
wherein validation of the first digital signature, by the second entity system, determines if the set of code in the signed code package has been altered since the second entity system applied the first digital signature to the set of code.

13. The one or more non-transitory computer-readable media of claim 12, the operations further comprising:
providing, by the first entity system, the signed code package to the target computing environment;
wherein the interface exposed by the first entity system allows the second entity system to validate the first digital signature in the target computing environment.

14. The one or more non-transitory computer-readable media of claim 13:
wherein the signed code package comprises an unextracted copy of the set of code to be deployed to the target computing environment;
wherein to validate the first digital signature, the second entity system accesses the signed code package in the target computing environment via the interface.

15. The one or more non-transitory computer-readable media of claim 13, wherein to validate the first digital signature, the second entity system accesses the first digital signature in the target computing environment via the interface.

16. The one or more non-transitory computer-readable media of claim 12, wherein the second entity system validates the first digital signature in the target computing environment before the first entity system finishes deploying the set of code to the target computing environment.

17. The one or more non-transitory computer-readable media of claim 12, wherein the second entity system validates the first digital signature in the target computing environment after the first entity system finishes deploying the set of code to the target computing environment.

18. The one or more non-transitory computer-readable media of claim 17, the operations further comprising:
receiving, by the first entity system from the second entity system, the validation signal;
determining, by the first entity system, if the validation signal indicates that the first digital signature is valid;
responsive to determining that the validation signal indicates that the first digital signature is not valid: performing, by the first entity system, one or more remedial actions with respect to the set of code deployed to the target computing environment.

19. The one or more non-transitory computer-readable media of claim 18, the operations further comprising:
receiving, by the first entity system from the second entity system in association with the validation signal, an instruction to perform the one or more remedial actions with respect to the set of code deployed to the target computing environment;
wherein performing the one or more remedial actions is performed responsive to receiving the instruction to perform the one or more remedial actions.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
obtaining, by a first entity system from a second entity system, a signed code package comprising a first digital signature applied by the second entity system to a set of code to be deployed to a target computing environment;
exposing, by the first entity system, an interface for the second entity system to validate the first digital signature and communicate a validation signal to the first entity system;
wherein the first digital signature indicates that the set of code satisfies one or more deployment criteria enforced by the second entity system;
wherein validation of the first digital signature, by the second entity system, determines if the set of code in the signed code package has been altered since the second entity system applied the first digital signature to the set of code.
